(19) United States
(12) Patent Application Publication
(10) Pub. No.: US 2024/0303041 A1
(43) Pub. Date: Sep. 12, 2024

(54) APPARATUS AND METHOD FOR ENERGY-EFFICIENT AND ACCELERATED PROCESSING OF AN ARITHMETIC OPERATION

(71) Applicant: SOLID STATE OF MIND, Montréal (CA)

(72) Inventors: Maxime Julien, Mont-Royal, CA (US); Etienne Dumesnil, Saint-Basile-le-Grand (CA)

(21) Appl. No.: 18/579,944

(22) PCT Filed: Jul. 22, 2022
(86) PCT No.: PCT/CA2022/051140

§ 371 Date: Jan. 17, 2024

Related U.S. Application Data
(60) Provisional application No. 63/225,134, filed on Jul. 23, 2021.

(51) Int. Cl. G06F 7/57; G06F 9/30

(52) U.S. Cl. CPC G06F 7/57; G06F 9/3001; G06F 9/30094; G06F 9/30101; G06F 9/30109

(57) ABSTRACT

An apparatus and a method for accelerated processing of an arithmetic operation. The apparatus comprises an operand pre-arithmetic status register configured to generate a status notification that flags that one of predetermined combinatory conditions between a first operand and a second operand is met; and a modified arithmetic logic unit. The modified arithmetic logic unit comprises an electronic logic circuit configured to, in response to receiving the status notification from the operand pre-arithmetic status register, readdress execution of the arithmetic operation towards an expedited routine within the modified arithmetic logic unit if the status notification comprises one or more flags or to a conventional routine if the status notification is a blank status notification, the expedited routine having less calculation cycles to output an operation result than the conventional routine.

### RELATED APPLICATION

The present application claims priority to or benefit of U.S. provisional patent application No. 63/225,134, filed Jul. 23, 2021, which is incorporated herein by reference in its entirety.

### TECHNICAL FIELD

The present disclosure relates to computer processors, and more specifically, to methods and apparatuses for accelerating and improving energy efficiency of calculations by computer processors.

### BACKGROUND

Computers and servers perform arithmetic calculations using conventional arithmetic logic units (ALUs). A conventional arithmetic logic unit (ALU) is a digital circuit which can be used in computing circuits, such as a central processing unit (CPU) of computers or servers. When the CPU is tasked to calculate an arithmetic operation, the conventional ALU extensively executes numerous calculation cycles, which may be energy- and time-consuming.

### SUMMARY

It is an object of the present disclosure to provide apparatuses and methods for simplifying and accelerating of processing of arithmetic calculations to alleviate calculation needs and thereby improve energy efficiency of various types of processors. Apparatuses and methods for energy-efficient and accelerated processing of an arithmetic operation are provided herein.

By not performing useless calculations, the apparatuses and methods described herein permit to lower power consumption. The apparatuses and the methods described herein provide pre-screening of arithmetic calculation operands to avoid useless calculations in arithmetic and logic units (ALUs) of a processor. Such pre-screening may permit to reduce the energy consumed by the processor. The processor may be, for example and without limitation, a central processing unit (CPU), a graphics processing unit (GPU), a tensor processing unit (TPU), a digital signal processor (DSP), and a microcontroller (MCU).

An apparatus and a method for accelerated processing of an arithmetic operation are provided. In at least one embodiment, the apparatus comprises an operand pre-arithmetic status register configured to generate a status notification that flags that one of predetermined combinatory conditions between a first operand and a second operand is met; and a modified arithmetic logic unit. The modified arithmetic logic unit comprises an electronic logic circuit configured to, in response to receiving the status notification from the operand pre-arithmetic status register, readdress execution of the arithmetic operation towards an expedited routine within the modified arithmetic logic unit if the status notification comprises one or more flags or to a conventional routine if the status notification is a blank status notification, the expedited routine having less calculation cycles to output an operation result than the conventional routine.

According to one aspect of the disclosed technology, there is provided an apparatus for accelerated processing of an arithmetic operation, the apparatus comprising: an operand pre-arithmetic status register configured to receive a first operand and a second operand and to generate a status notification that flags that one of predetermined combinatory conditions between the first operand and the second operand is met; and a modified arithmetic logic unit (ALU) configured to: receive the first operand and the second operand and the status notification and in response to receiving the status notification from the operand pre-arithmetic status register that flags that one of the predetermined combinatory conditions is met, readdress at least one of the first operand and the second operand to an appropriate routine having less calculation cycles to output a result with a smaller number of calculation cycles. In at least one embodiment, the operand pre-arithmetic status register comprises an electronic logic circuit which is configured to implement combinatory logics. The operand pre-arithmetic status register may comprise an electronic logic circuit which is configured to implement sequential logics. The status notification may be a series of bit having at least one bit is for flagging one of the predetermined combinatory conditions. A position of the bit with a flag in the status notification may correspond to a specific one of the predetermined combinatory conditions. In at least one embodiment, the modified ALU may be configured to execute an additional microcode to redirect at least one operand to a pre-determined pipeline based on the status notification received. Receiving the first and the second operand may comprise receiving an indication of an arithmetic operation to be performed with the first and the second operand.

According to one aspect of the disclosed technology, there is provided an operand pre-arithmetic status register for assisting the modified arithmetic logic unit (ALU) to accelerate processing of an arithmetic operation, the operand pre-arithmetic status register configured to: receive a first operand and a second operand, and generate a status notification to be transmitted to the modified ALU, the status notification being generated based on a predetermined combinatory condition being met between the first operand and the second operand. The status notification may be a sequence of bits, one of the bits serving as a flag of the predetermined combinatory condition. The position of the flag in the sequence of bits may indicate the predetermined combinatory condition between the first operand and the second operand.

According to one aspect of the disclosed technology, an apparatus for accelerated processing of an arithmetic operation is provided. In at least one embodiment, the apparatus comprises: an operand pre-arithmetic status register configured to receive a first operand and a second operand and to generate a status notification that flags that one of predetermined combinatory conditions between the first operand and the second operand is met; and a modified arithmetic logic unit comprising an electronic logic circuit configured to: receive the first operand and the second operand, and the status notification, and in response to receiving the status notification from the operand pre-arithmetic status register that comprises at least one flag indicating that one of the predetermined combinatory conditions is met, readdress execution of the arithmetic operation by the modified arithmetic logic unit towards an expedited routine having less calculation cycles to output an operation result than a conventional routine, the conventional routine being executed in response to the status notification, received from the operand pre-arithmetic status register, being a blank status notification. In the apparatus, the operand pre-arithmetic status register may be configured to receive an operation indication, and the generating, by the operand pre-arithmetic status register, the status notification may be further based on the operation indication.

In at least one embodiment, the modified arithmetic logic unit may be configured to receive an operation indication and wherein, in response to receiving the status notification from the operand pre-arithmetic status register that comprises at least one flag indicating that one of the predetermined combinatory conditions is met, analyze the operation indication and readdress the execution of the arithmetic operation to the expedited routine based on the operation indication. The electronic logic circuit may be configured to implement combinatorial logics. The electronic logic circuit may be configured to implement sequential logics. The status notification may be a series of bits having at least one bit for flagging one of the predetermined combinatory conditions. A position of the bit with a flag in the status notification may correspond to a specific one of the predetermined combinatory conditions. The modified arithmetic logic unit may be configured to execute an additional microcode to redirect at least one operand to a pre-determined pipeline based on the status notification received. Receiving the first operand and the second operand may comprise receiving an operation indication indicative of the arithmetic operation to be performed with the first operand and the second operand.

In at least one embodiment, the status notification may be generated based on an indication of available or allotted energy of an energy source received by the operand pre-arithmetic status register. The status notification may be generated based on an indication of available or allotted energy of an energy source received by the modified arithmetic logic unit. The readdressing of the execution of the arithmetic operation by the modified arithmetic logic unit is based on an indication of available or allotted energy of an energy source received by the modified arithmetic logic unit. The predetermined conditions may comprise available or allotted energy of an energy source being lower than a threshold level. The status notification may be generated based on determining and comparing a first range of the first operand and a second range of the second operand. The operand pre-arithmetic status register may comprise logic gates, each logic gate configured to recognize at least one predetermined combinatory condition. Each logic gate may raise a flag if one predetermined combinatory condition is satisfied (recognized). The logic gate may provide an indication that permits to generate the flag in the status notification.

According to another aspect of the disclosed technology, an operand pre-arithmetic status register for assisting a modified arithmetic logic unit to accelerate processing of an arithmetic operation is provided. In at least one embodiment, the operand pre-arithmetic status register is configured to: receive a first operand and a second operand, and generate a status notification to be transmitted to the modified arithmetic logic unit, the status notification being generated based on a predetermined combinatory condition being met between the first operand and the second operand. The status notification may be a sequence of bits, one of the bits serving as a flag of the predetermined combinatory condition. A position of the flag in the sequence of bits may indicate the predetermined combinatory condition between the first operand and the second operand. The operand pre-arithmetic status register may further comprise logic gates, each logic gate configured to recognize at least one predetermined combinatory condition.

According to another aspect of the disclosed technology, there is provided a method for accelerated processing of an arithmetic operation, the method executable by an apparatus comprising an operand pre-arithmetic status register and a modified arithmetic logic unit. In at least one embodiment, the method comprises: receiving, by the operand pre-arithmetic status register, a first operand and a second operand; generating, by the operand pre-arithmetic status register, a status notification that flags that one of predetermined combinatory conditions between the first operand and the second operand is met; receiving, by the modified arithmetic logic unit, the first operand and the second operand and the status notification; and in response to receiving the status notification from the operand pre-arithmetic status register that comprises a flag indicating that one of the predetermined combinatory conditions is met, readdressing execution of the arithmetic operation, by the modified arithmetic logic unit, towards to an expedited routine corresponding to the flag in the status notification, the expedited routine having less calculation cycles than a conventional routine executed when the status notification is a blank status notification.

The method may further comprise receiving, by the operand pre-arithmetic status register, an operation indication and the generating, by the operand pre-arithmetic status register, the status notification may be further based on the operation indication. The status notification may be a sequence of bits having at least one bit for flagging one of the predetermined combinatory conditions. The position of a bit with a flag in the status notification may correspond to a specific one of the predetermined combinatory conditions. The method may further comprise executing, by the modified arithmetic logic unit, an additional microcode to redirect at least one operand to a pre-determined pipeline based on the status notification received. In at least one embodiment, receiving the first and the second operand comprises receiving an indication of the arithmetic operation to be performed with the first operand and the second operand. The method may further comprise assigning to a pre-determined bit of the status notification a value of 1 in response to the predetermined combinatory conditions between the first operand and the second operand being met.

The generating of the status notification may be also based on an indication of available or allotted energy of an energy source received by the operand pre-arithmetic status register. The generating of the status notification is based on an indication of available or allotted energy of an energy source received by the modified arithmetic logic unit. The readdressing of the execution of the arithmetic operation by the modified arithmetic logic unit may be based on an indication of available or allotted energy of an energy source received by the modified arithmetic logic unit. The predetermined conditions may comprise available or allotted energy of an energy source being lower than a threshold level. The generating of the status notification may be based on determining and comparing a first range of the first operand and a second range of the second operand.

### BRIEF DESCRIPTION OF THE DRAWINGS

Further features and advantages of the present disclosure will become apparent from the following detailed description, taken in combination with the appended drawings, in which:

FIG. 1 is a schematic block diagram of a conventional arithmetic and logic unit (ALU);

FIG. 2 depicts a schematic block diagram of an apparatus for processing an arithmetic operation, in accordance with at least one embodiment of the present disclosure;

FIG. 3 depicts a schematic block diagram of a status register and a status notification, in accordance with at least one embodiment of the present disclosure; and

FIG. 4 depicts a method for accelerated processing of an arithmetic operation, in accordance with at least one embodiment of the present disclosure.

It will be noted that throughout the appended drawings, like features are identified by like reference numerals.

### DETAILED DESCRIPTION

Various aspects of the present disclosure generally address one or more of the problems of accelerating processing of an arithmetic operation. To accelerate processing of the arithmetic operations by arithmetic and logic units (ALUs) of a computer or a server, and to save the energy used by the ALUs during the calculations, it is desirable to reduce the number of calculation cycles, and, more specifically, to reduce the number of arithmetic operations performed by the ALUs to arrive at a given result. To reduce the number of calculation cycles, the operations, where the result may be achieved in a more straightforward manner, may be simplified. In accordance with the present disclosure, the result may be achieved in a more straightforward manner for trivial operations, such as, for example, where the result may be obtained in one step or only a few steps instead of several, or where the operation has no effect (e.g. unnecessary operations such as +0, −0, ×1 or /1).

A central processing unit (CPU) performs various operations, such as arithmetic, logic, controlling, and input/output operations. A conventional arithmetic logic unit (ALU) is usually located in the CPU and is configured to perform the arithmetic operations. The ALU may be located in any processor, such as, for example, a graphics processing unit (GPU), a tensor processing unit (TPU), a digital signal processor (DSP), a microcontroller (MCU), etc.

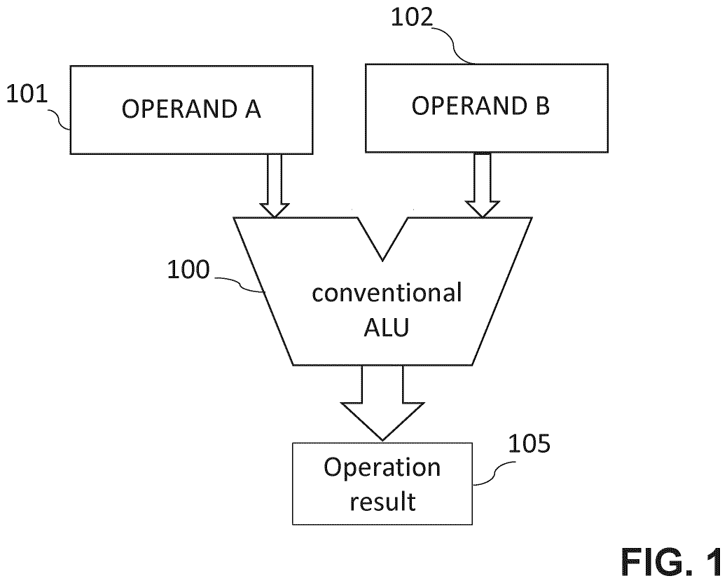

Referring now to the drawings, FIG. 1 schematically demonstrates operation of the conventional ALU 100 where, based on an operand A 101 (also referred herein as a “first operand 101”) and an operand B 102 (also referred herein as a “second operand 102”), the conventional ALU 100 generates an operation result 105. For example, the operation performed by the ALU 100 may be a division, a multiplication, an addition or a subtraction. The operands 101, 102 may be, for example, scalar or packed values.

For example, when the processor is operating at X MHz, there are X million cycles per second performed by the conventional ALU. One operation of division may correspond to 80 cycles performed by the conventional ALU 100 to arrive at the expected result of said operation.

In some cases, however, it may be useless to perform some arithmetic operations with the conventional ALU 100. For example, the arithmetic operation may be “A×B” where the numbers given to the ALU are such that B=1, and the result of the operation “A×B” is therefore necessarily A. In another example, the operation may be “A/B” (in other terms, first operand to be divided by the second operand) and the numbers given to the conventional ALU 100 may be such that A=B. Executing such arithmetic operations, or similar ones, using the conventional ALU 100 would entail using very precious calculation cycle time for something that does not need. If or when the conventional ALU 100 is tasked to execute such an operation, the conventional ALU 100 usually performs approximately 80 cycles to perform the division, for example, even though the result may be known (or, in other words, predicted) in advance without actually having to perform all cycles to obtain the result of the division operation. Such a result may be programed in advance using the technology described herein.

Currently, a compiler that assembles an executable file can catch some of these unnecessary operations, such as “A×1”. However, many unnecessary arithmetic operations cannot be caught by the compiler at a software level especially if the program uses arbitrary variables A and B and the values of A and B eventually make the operation trivial or unnecessary. Such useless operations may be intercepted at run time using the apparatus and method described herein.

One example of the unnecessary arithmetic operations not caught by the compiler may be, for example, performing an operation of division a/b where the dividend (or numerator) a is equal to a divisor (or denominator) b. For example, if a program to be compiled and executed by the processor comprises the operation of “A/B” (in other terms, the first operand divided by the second operand), the compiler would not remove this operation because it does not detect it to be trivial (as it is generally not trivial). Therefore, if the compiled program is executed by the processor and it happens that A=B (first operand is equal to the second operand), then the operation becomes trivial, but the compiler did not know that in advance. In such a circumstance, the processor would therefore spend time executing cycles to perform the operation despite its triviality.

Another example of the trivial or unnecessary operation is a division where the divisor is equal to 1. For multiplication operation, when one of the operands is zero, the result is zero. Again, if the program includes predetermined multiplication by zero or division by one, the compiler will normally catch it and avoid having the processors deal with these operations. However, if these operations are made because an arbitrary denominator happens to be equal to one, or an arbitrary multiplicator happens to be zero or one, the compiler will not catch it and the ALU will be tasked to perform such a trivial or unnecessary operation because of the ad hoc value of at least one of the operands. The same problem would happen should the compiler not catch any trivial or unnecessary operation for any reason.

Table 1 provides a non-exhaustive list of the unnecessary arithmetic operations for multiplication and divison.

TABLE 1
A non-exhaustive list of the unnecessary arithmetic
operations for multiplication and division which the
ALU may be tasked when not caught by the compiler

| Relational Condition | Operation Result |
|---|---|
| For Multiplication: | |
| When one of the operands is zero | result is zero |
| When one of the operands is one | result is the other operand |
| When one of the operands is minus one (−1) | result is the other operand |
| | with a negative sign |
| When one of the operands is a power of two | result is a bit shift operation |
| For Division: | |
| When the dividend is zero | result is zero |
| When the dividend and divider are equal | result is one |
| When the divider is zero | result is infinite |
| When the divider is one | result is the dividend |
| When the divider is a power of two | result is a bit shift |

Similar unnecessary operations may be identified, without limitation, for an addition, a subtraction, a calculation of a square root, of a logarithm, etc. For example, multiplication by 2, incrementing a value by 1 (A+B, where B=1), subtraction of 1 (A−B, where B=1), may be solved at a bit level, without any need of actual calculation. Calculating a logarithm in many cases may be avoided when the answer may be determined without actual calculation (such as, for example, “logₓ(xⁿ)”).

Regarding bit shift operations which can be made instead of standard multiplications or divisions by the ALU, those are the operations where the multiplication or the division is made with a multiplicator or denominator which is the same as the basis of the numeral system used to represent the number. For example, in the case of an initial number represented in a binary numeral system, which is typical in computers, such as two, represented as “10” in binary (referred to herein as an “initial binary number”), multiplied by two (the basis of the numeral system), would result in a shift to the left of “1” and corresponding to an additional zero at the right side of the binary representation of the initial binary number “10”, which is “100” in binary and corresponds to “four”. The number of zeros added to the right of the initial binary number corresponds to the power of the basis used in the multiplication, e.g., if the binary number is multiplied by eight, which is 23, the number of zeros added to the initial binary number “10” would be three.

The same method may be used for a division, e.g., if number eight, of which the binary representation is “1000”, is divided by four, which is 22, then two zeros corresponding to the exponent may be shifted out at the right of the binary number “1000” to arrive to the result: binary “10” which is two. The same principle may be applied to numerical system with other bases (not only binary numbers in base 2, such as 10 or 16), although computer processors overwhelmingly use binary numbers (in base 2).

The execution of a simple task of shifting trailing zeros (for example, shifting the zeros to the right of the binary numbers) is much faster than the execution time of a plurality of cycles (for example, 80 cycles) which may be needed to perform the same computation by the conventional ALU 100 and to arrive at the same result in the end. In a binary format, it means that the multiplication of any number by a power of two (2⁰, 2¹, 2², 2³, 2⁴, 2⁵, and so on) would be much faster. The division of any number with sufficient trailing zeros by a power of two which is at most as large as the number of trailing zeros of that number would also be accelerated by the mere deletion of the number of trailing zeros corresponding to the power of two of the denominator. In a practical and frequent example, it reduces considerably the time of performing (executing an operation of) a division by two of even numbers by removing the right-side zero of the binary representation of that number to arrive at the result faster than if the conventional ALU 100 was tasked to perform the division in the longer conventional (typical) way.

The condition to be verified corresponds to when at least two of: the arithmetic condition, the first operand and the second operand meet predefined criteria between them, such as those listed above in Table 1 and other similar operations as discussed above. The method and an apparatus described herein allow for readdressing operands inputted into the ALU into a more straightforward routine to be executed by ALU (in other terms, readdressing execution of the arithmetic operation towards the more straightforward routine) and thereby avoid any unnecessarily lengthy calculations by the ALU based on the information received about a particular predetermined condition for the operands verified to be met for a given operation.

The present description provides an apparatus and a method to avoid having the CPU execute useless calculations by pre-emptively analysing the arithmetic operands 101, 102. Such pre-emptive analysis permits to draw immediate, one-step conclusions or to choose better means of calculation than the CPU's intensive original operation involving a plurality of cycles performed by the ALU. The pre-emptive analysis of the arithmetic operands (prior to performing the calculations by a conventional ALU) permits reducing the number of the overall CPU cycles, thus reducing the energy used by the computers and servers.

In the embodiments described herein, the pre-emptive analysis is performed at a hardware level, by introducing a new prescreening hardware to operate along with the conventional ALU of the processor.

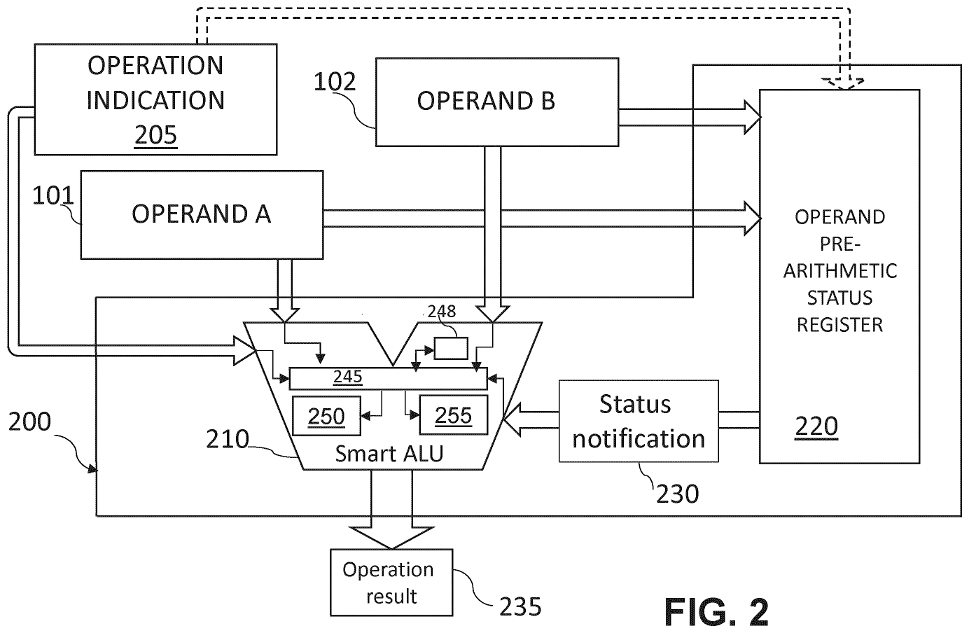

FIG. 2 depicts an apparatus 200 for processing an arithmetic operation, in accordance with at least one embodiment of the present disclosure. The apparatus 200 comprises a smart ALU 210 (also referred to herein as “SALU 210” and a “modified arithmetic logic unit”) and an operand pre-arithmetic status register 220 (also referred to herein as “register 220”). Both the SALU 210 and the register 220 receive operands 101, 102 (also referred to herein as a first operand 101 and a second operand 102). In some embodiments, the operands 101, 102 may be received simultaneously by the SALU 210 and the register 220.

According to a preferred embodiment, after the register 220 receives the first and the second operands 101, 102, the register 220 analyses a predetermined condition, which is a relational or combinatory condition between 1) the first operand and/or 2) the second operand, and/or 3) one or more predetermined constants. The register 220 determines the existence of such a predetermined condition between the operands, such as listed in Table 1. Relational and/or combinatory condition between the operands may include comparison of one or both operands to one or more predetermined constants. The predetermined constants may be, for example, 1, 0, −1, etc. The relational and/or combinatory conditions may be, for example, A=B, A=1, A=0, B=1, B=0, A roughly equal to B, etc.

For example, the register 220 compares the first and second operands 101, 102 to each other, to 1 and/or to zero. In a similar vein, if the register 220 is programmed to identify operations requiring only a bit shift, it can identify an operand as being a power of two. In other terms, the register 220 flags situation in which the operation to be executed by the SALU 210 may be trivial or unnecessary, depending on the arithmetic operation, and based on the identification that a predetermined combinatory condition is met or not between the two inputs into the register 220: first operand A and second operand B. Based on such analysis of the operands 101, 102, the register 220 generates a status notification 230. The SALU 210 then determines, based on the status notification 230, in view of the arithmetic operation indication 205 (illustrated in FIG. 2 and referred to herein as “operation indication 205”) to be performed, if readdressing of the operands in the built-in routines is appropriate, as detailed further below.

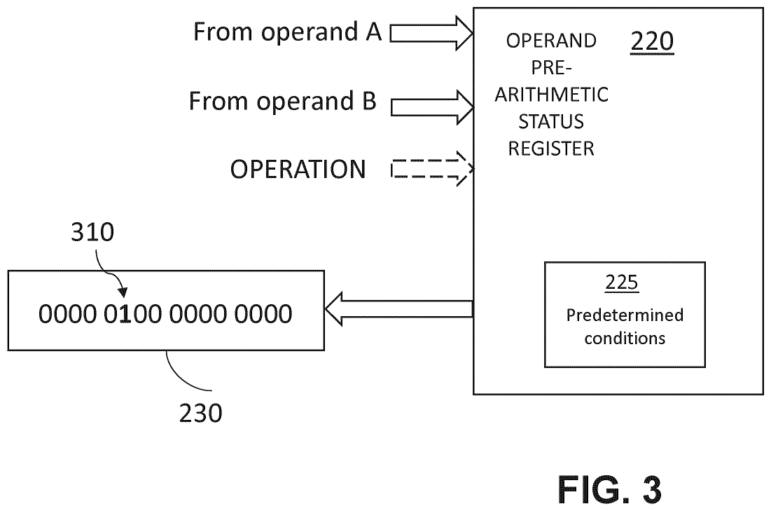

In at least one embodiment, the register 220 generates a status notification 230 which is configured to flag a specific condition. In at least one embodiment, the status notification 230 is a sequence of bits (in other terms, a series of bits), comprising, for example, N bits, where N is an integer. An example of the status notification 230 is illustrated in FIG. 3. In such a sequence of bits, each bit (or a specific number of bits) are assigned for indicating (in other terms, flagging) a specific condition. In other terms, one of the bits of the sequence of bits serves as a flag of the predetermined combinatory condition.

For example, a predetermined condition of A=B may correspond to bit 0 of the sequence of bits of the status notification 230, A=1 may correspond to bit 1 of the sequence of bits of the status notification 230, B=1 may correspond to bit 2 of the sequence of bits of the status notification 230, etc. In other terms, the register 220 may, for example, generate the status notification 230 which has the 0-th bit in the status notification 230 equal to 1 when A=B (i.e. when A is equal to B). If A is not equal to B, then the 0-th bit in the status notification 230 generated by the register 220 may be assigned to be “0”. In other terms, in response to A being equal to B, a particular bit (0th bit, for example) is “1”, while if A is not equal to B, the same (for example, 0^{th}) bit in the status notification 230 is set to be (in other terms, assigned to be) “0” by the register 220.

For example, the register 220 the status notification 230 generated by the register 220 may have the first bit (or any other pre-determined bit) which is equal to 1, when A is equal to 1 (A=1). If A is not equal to 1, then the first bit in the status notification 230 generated by the register 220 is 0. In other terms, in response to the first operand (operand A) 101 being equal to 1, a particular bit (first bit, for example) of the status notification 230, is 1, while if the first operand (operand A) is not equal to 1, the same bit in the status notification 230 is set to be (in other terms, assigned to be) “0” by the register 220.

In at least one embodiment, the register 220 is made of a combinatorial logic that is configured to issue the status almost instantaneously after being presented with operand A and B. Therefore, in such a configuration, the SALU 210 receives the first and the second operands (A, B) 101, 102, and the status notification 230.

Although the embodiment just described is preferred, according to another alternative embodiment, the register 220 may take into account the arithmetic operation indication 205. In this alternative embodiment, after the register 220 receives the first and the second operands 101, 102, the register 220 analyses a predetermined condition, which is a relational or combinatory condition between 1) the arithmetic operation, indicated with the operation indication 205, to be performed, 2) the first operand and 3) the second operand; and determines the existence of such a predetermined condition between the arithmetic operation indication 205 and the operands 101, 102, such as listed in Table 1.

For example, the register 220 may compare the operands to each other, to 1 and/or to zero. The relevance of having each of the operands equal to each other, to 1 and/or to zero may depend on the arithmetic operation (and therefore operation indication 205 corresponding to the arithmetic operation) to be performed, and therefore, the register 220 may advantageously comprise arithmetic and logic circuitry which implement combinatory logic to determine if the combination of three values (first operand A, second operand B and arithmetic operation indication) belongs to any predetermined condition. In a similar vein, if the register 220 is programmed to identify operations requiring only a bit shift, it may identify an operand as being a power of two. In other terms, the register 220 determines whether the operation, provided by operation indication 205, to be executed by the SALU 210 is a trivial or unnecessary arithmetic operation based on the identification that a predetermined combinatory condition is met or not between, in this embodiment, the three inputs into the register: first operand A 101, second operand B 102, and the arithmetic operation indication 205. Based on such analysis of the arithmetic operation indication 205, the operands 101, 102, the register 220 in such an embodiment, generates the status notification 230 for the SALU 210 in which the arithmetic operation indication 205 was already considered when flagging a situation and outputting such a flag 310 (illustrated in FIG. 3) as a status notification 230, thereby relieving the SALU 210 from the task of analyzing the operation indication 205.

The description below is based on the preferred embodiment where the status notification 230 is based only on the first and second operands A and B 101, 102, and the SALU 210 then determines if routine readdressing is appropriate based on the status notification 230 and the arithmetic operation.

In at least one embodiment, the register 220 may be implemented using a sequential logic when configured such that the total number of cycles to be performed by SALU 210 and the register 220 is less than the number of cycles that the conventional ALU 100 would perform.

In at least one embodiment, the register 220 comprises an electronic logic circuit which is configured to implement combinatorial logics. In other terms, the register 220 may have an electronic logic circuit for implementing combinatorial logics. In such embodiment, the register 220 comprises electronics, such as logic gates and registers, which implement combinatorial logics (also referred to herein as “combinatory logics” and may be also referred to as “combinational logic”). The combinatorial logics has the output as a pure function of the present input. The combinatorial logics is in contrast to sequential logic, which has the output depending not only on the present input, but also on the previous input. In at least one embodiment, the register 220 comprises an electronic logic circuit which is configured to implement sequential logics. Thus, the register 220 may have the electronic logic circuit for implementing sequential logics.

The electronic logic circuit of the register 220 verifies whether the predetermined combinatory conditions are met. For example, such predetermined combinatory condition may be: operands are equal, one of the operands is zero, one of the operands is one, both of the first and second operands 101, 102 are zero, both of the first and second operands 101, 102 are one, one of the operands (the first operand 101 or the second operand 102) is an even number, one of the operands is a power of two, and so on. In an alternative embodiment, in which the register 220 also takes into account the arithmetic operation indication 205, the predetermined combinatory conditions may additionally include: multiplication by zero, multiplication by one, addition of zero, etc. When one of the predetermined combinatory conditions is met, the register 220 flags which of the conditions are met.

As illustrated in FIG. 3, the register 220 may have logic gates 225 (which may be also referred to as a “register logic gates 225” or a “set of logic gates 225”) configured to verify and recognize the predetermined combinatory conditions. Each logic gate may be configured to raise a flag if it recognizes the fulfillment of one predetermined condition (in other terms, when the predetermined condition is met). The logic gates 225 may therefore compare the first operand 101, the second operand 102, and the predetermined constants. In at least one embodiment, the register 220 may also comprise a register memory.

According to an embodiment, the output of the register 220, depicted in FIGS. 2 and 3 as status notification 230, comprises a series of bits. The series of bits of the status notification 230 may include a “1” at a specific position (at a specific bit) to flag the corresponding condition that was met. An example of the status notification 230 is depicted in FIG. 3. Each possible position of the flagging bit “1” in the status notification 230 corresponds to one of the conditions. The logic gates 225 (and/or, in some embodiments, a register memory) may store the correspondence of the bits of the status notification 230 to the predetermined conditions in order to assign the flag to the specific bit corresponding to specific predetermined condition, for the SALU 210 to then recognize such predetermined condition.

The register 220 transmits the status notification 230 to the SALU 210. The register 220 continuously provides the status notification 230 for every set of the first and second operands 101, 102. The SALU 210 receives and reads the status notification 230 to determine whether any of the bits are set to “1” in order to proceed with the execution of the operation according to the information received in the status notification 230. When the SALU 210 receives the status notification 230, detecting the presence of “1” at a given bit position in the status notification 230 triggers a re-addressing inside the SALU 210. The SALU 210 then performs the calculations in a usual way, or an expedited way, based on the status notification 230.

In other words, in response to receiving the status notification 230, the SALU 210 processes the first and second operands 101, 102 according to the flag 310 received in the status notification 230 to generate an operation result 235 based on the first operand 101, the second operand 102, and the status notification 230. The SALU 210 decides what to do, how to process the operands, and provides the operation result 235. Referring to FIGS. 2-3, the first and second operands A and B 101, 102 are fed to the SALU 210 along with the status notification 230, which is a series of bits that may include the flag 310.

In at least one embodiment, the SALU 210 may have the same hardware as a conventional ALU 100. In addition to the hardware and software of a conventional ALU 100, the SALU 210 has an additional microcode for processing incoming data, such as the status notification 230. When the status notification 230 has the flag 310, the first and second operands 101, 102 are redirected in an appropriate pipeline (shortened routine) of the SALU 210 for a more efficient treatment. As illustrated in FIG. 2, the smart ALU 210 has a conventional routine 250 and an expedited routine 255.

Such additional microcode of the SALU 210, which comprises the routing routine 245, executes the operation, indicated by the operation indication 205, by re-addressing the values to specific sub-routines of calculation (such as the expedited routine 255), which are more efficient. In at least one embodiment, SALU 210 may be configured to execute the additional microcode, instead of the conventional microcode of the conventional ALU, when the predetermined conditions are met and flagged by the status notification 230.

When a conventional ALU 100 receives an instruction like “DIV A, B” (which requests execution of the division operation of the first operand to the second operand, that is, A/B), receiving such an instruction triggers an internal series of operations dictated by the microcode of the processor. The SALU 210 works in the same way as the conventional ALU 100 as long as (while) the status notification 230 received from the register 220 contains no flag 310.

When the status notification 230 does not have any flag 310, the status notification 230 is referred to herein as a “blank status notification”. Such a blank status notification may comprise only zeroes, or have another pre-determined sequence of bytes that are configured to indicate to the SALU 210 that there are no flags and therefore none of the pre-determined conditions are met by the first and second operands 101, 102 and, in some embodiments, by the operation indication 205. The blank status notification comprises zero flags 310 that would indicate that at least one predetermined condition stored in and verified by the logic gates 225 is met. Without the flag, the conventional routine 250 is executed by the SALU 210.

As described above, the flag 310 may be located at a position of any bit in the status notification 230. For each predetermined combinatory condition of the predetermined combinatory conditions, the register 220 assigns (maps) a corresponding bit in the status notification 230.

The register 220 assigns the value of 1 or 0 for each one of the bits of the status notification 230, where the value of each bit corresponds to a flag meaning whether the particular predetermined combinatory condition of the set of the predetermined combinatory conditions (located in and verified by logic gates 225) is fulfilled or not.

In the SALU 210, the received (and detected) flag 310 in the flag-containing status notification 230 triggers a different set of microcode instructions, which is also referred to herein as the expedited routine 255, to be executed. Such set of microcode instructions may be very short to execute and are used to re-address (if relevant based on the flag 310 and the arithmetic operation) the operands into a routine which is much faster within the SALU 210. In other words, the microcode instructions of the expedited routine 255 may be executed significantly faster (for example, two or several times faster) than the conventional routine 250. For example, the execution of the microcode instructions (for example, routing routine 245) may determine that a given flag 310 received and the given arithmetic operation, indicated by the operation indication 205, to be performed (executed) on the corresponding first and second operands 101, 102 that are received should instruct to place the value of the first operand A 101 (i.e., readdress operand A) into Result and return (i.e., output the operation result 235). In such a case, the expedited routine 255 places the value of the first operand 101 into the operation result 235.

For example, a division of operands A and B may be directed or addressed, by default, to the conventional routine 250 of the SALU 210, which performs a division (about 80 cycles to perform). However, if there is a flag 310 in the status notification 230, i.e., a bit set at 1 at a specific position in the register's output status notification 230, indicating that the denominator B equals 1 (B=1), then the SALU 210, would force the execution of the added microcode which corresponds to the expedited routine 255 of the SALU 210 and determine that this flag 310 (flag in the status notification 230 indicating that B=1) is appropriate to consider for routine re-addressing when performing a division. Such added microcode (expedited routine 255) re-addresses the incoming operation request and, for an example with B=1, puts the operand A right into the result of the operation (operation result 235), thereby making the division much more straightforward and skipping a great number of cycles.

In at least one embodiment, the routing routine 245 is configured to read the status notification 230 in order to detect the flag(s) 310 and to advance (routing, as a router) the execution towards the conventional routine 250 if there is no flag 310 or towards the expedited routine 255 if there is a flag 310 in the status notification 230.

In other examples, if the flag 310 in the status notification 230 identifies that the first operand A is even and the second operand B is equal to 2 B=2 (which may be one of the predetermined combinatory conditions to be identified), the execution of the microcode by the routing routine 245 of the SALU 210 may determine that this flag 310 is relevant for readdressing to if the operation (expressed by the arithmetic operation indication 205) to be performed is a division of the first operand to the second operand: A/B. The routing routine 245 may therefore readdress the first and second operands A and B (in other terms, readdress the execution of the operation) to another (for example, built-in) routine, such as the expedited routine 255 (shift right by one bit), which performs division of an even number by 2, which is much more efficient in terms of the number of cycles to be executed than the general division which takes 80 cycles to which the operands A and B would normally have been addressed.

In at least one embodiment, the SALU 210 may comprise a plurality (a set) of expedited routines 255, each one corresponding to one of the predetermined conditions. The verification of the predetermined conditions may be implemented by the set of logic gates 225 that may raise a flag if they recognize a specific condition. One set of logic gates may be implemented for one predetermined condition. The logic gates 225 corresponding to the predetermined conditions are located in the register 220. In addition, the predetermined conditions may be also verified by SALU logic gates 248 located in the SALU 210 and the routing routine 245 may consult the SALU logic gates 248 after receiving the status notification 230. The SALU logic gates 248 may be implemented each for one predetermined condition. In some embodiments, a SALU memory may be located in SALU 210 and may be implemented as a list of the predetermined conditions and the expected corresponding position of the flag 310 in the status notification 230 and the corresponding expedited routine 255 of the plurality of expedited routines 255 where the execution needs to be directed if the flag is present in the corresponding position of the status notification 230. In at least one embodiment, preferably, instead of the memory (or, in some embodiments, in addition to the memory) the SALU logic gates 248 may be consulted in order to determine whether to direct the execution to the expedited routine 255.

Still referring to FIG. 2, the first and second operands 101, 102 may be scalar or packed values. SALU 210 as described herein may be configured to process fixed-point numbers and/or floating-point numbers as operands. In some embodiments, SALU 210 may be configured to process operands 101, 102 in a single precision floating-point format or in a double Higher precision floating-point format.

Based on the received status notification 230, the SALU 210 may shorten the execution of complex calculations, which include simple calculations such as those identified herein, and therefore reduce the number of calculation cycles executed by the SALU 210. By executing the expedited routine(s) 255 based on the received status notification 230, the SALU 210 may provide the operation result 235 without extensive calculations. This may permit to accelerate the arithmetic calculations. Moreover, the register 220 may permit to reduce the energy consumption because the number of calculations is reduced. Therefore, SALU 210 is not only faster than a conventional ALU 100, but uses much less electrical power to execute, and less power is needed to cool down the electronics, etc., which is beneficial in terms of the overall lowered energy consumption of the device where the SALU 210 is used.

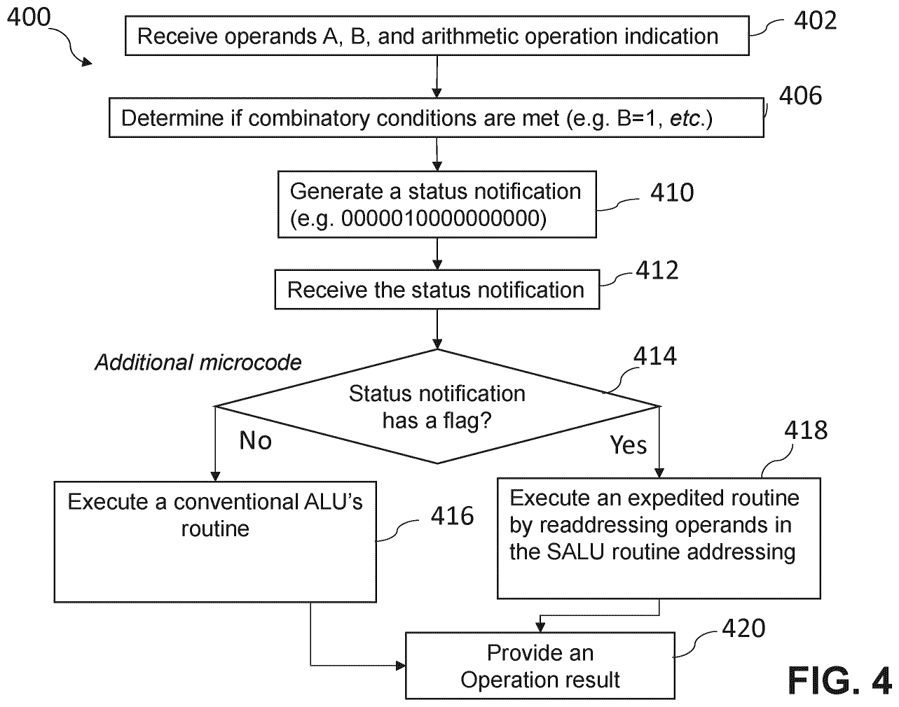

FIG. 4 depicts a method 400 for accelerated processing of an arithmetic operation, in accordance with at least one embodiment of the present disclosure. Although the steps of the method 400 are described herein in a sequential order and may be implemented in a sequential logic, a combinatorial logic is preferably used for implementation of method 400 and therefore the steps are implemented quasi-simultaneously (less propagation time) by combining operands 101 and 102. At step 402, first and second operands (A, B) 101, 102, and an arithmetic operation indication 205 are received. As described above, the arithmetic operation indication 205 may be received by the SALU 210 directly and, in addition, in some embodiments, the operation indication 205 may be also received by the register 220 as described above.

At step 406, the register 220 determines if relational conditions are met (e.g. B=1, etc.). As described above, the relational conditions may be verified for the first and the second operands 101, 102 and, in some embodiments, the arithmetic operation indication 205. At step 410, a status notification 230 is generated by the register 220. The status notification 230 is then transmitted to the SALU 210. At step 412, the status notification is received by the SALU 210. At step 414, the status notification 230 is analyzed by the SALU 210. For example, the status notification 230 may be analyzed by the routing routine 245. The routing routine 245 may consult the SALU logic gates 248 in order to determine to which expedited routine 255 the execution should be proceeded.

At step 416, if the flag 310 present in the status notification 230 (or, alternatively, in case of the flag's absence in the status notification 230) indicates that there is no unnecessary calculations to be done, the SALU 210 performs calculations of the conventional ALU 100 using the conventional routine 250 to determine and provide the operation result 235 at step 420. In other words, if the routing routine 245 determines that the status notification 230 is a blank status notification, the conventional routine 250 is executed by the SALU 210.

At step 418, if the flag 310 indicates that an unnecessary calculation would need to be performed, SALU 210 executes the expedited routine 255 to provide the operation result 235 at step 420. The expediting routine is executed by readdressing at least one of the first and the second operands 101, 102 to the expedited routine 255 (in other terms, readdressing execution of the operation towards the expedited routine 255) in the routine addressing of the SALU 210. In at least one embodiment, the expedited routine 255 has less calculation cycles to output an operation result 235 than the conventional routine 250.

The conventional routine 250 is executed in response to the status notification 230 received from the operand pre-arithmetic status register 220 being the blank status notification which indicates that there is no unnecessary calculation because the predetermined conditions are not met. The blank status notification may comprise zero flags. In other terms, in at least one embodiment, the electronic logic circuit of the SALU 210 is configured to execute microcode instructions with a conventional routine 250 and the expedited routine 255, and the conventional routine is executed in response to the status notification received from the operand pre-arithmetic status register comprising zero flags.

In at least one embodiment, the SALU 210 is configured to execute an additional microcode to redirect at least one operand to a pre-determined pipeline based on the status notification received.

The apparatus and the method as described herein may help to reduce the overall number of CPU cycles, thus reducing the energy used by computers and servers.

In at least one embodiment, the apparatus 200 may perform approximate calculations in order to conserve the energy. Based on the availability or allotted energy that powers the processor, and therefore SALU 210, the SALU 210 may use such an expedited routine based on approximations (and/or in some embodiments, that uses approximations) when the available or allotted energy is less than a threshold level, and a conventional routine 250 (or, in some embodiments, another expedited routine, but without approximations) when the available or allotted energy is equal to or higher than the threshold level. In at least one embodiment, the register 220 and/or the SALU 210 may determine ranges of each one of the operands: a first operand range of the first operand and a second operand range of the second operand. A range of the operand may be determined as a set of values within for instance ±2% of the value of the operand, ±5% of the value of the operand, ±10% of the value of the operand, or another predetermined deviation from the value of the operand. In at least one embodiment, the predetermined conditions may include comparing values within the range of the first operand A (for example, within x % of the value of A, wherein x may be any number equal or less than, for example, 5) with values within the range of the second operand B (for example, within x % of the value of A, wherein x may be equal or less than, for example, 5) and/or with one or more pre-determined constants (0, 1, 2, etc.). In at least one embodiment, the range of the operand may change dynamically.

The ranges of the operands may be then considered by the register 220 (and, in some embodiments, by the SALU 210) during the determination whether the combinatory conditions are met. For example, when the operation is A divided by B, if the value of the first operand A is sufficiently close to the value of the second operand B (in other words, when the value and/or the range of the first operand A is within the range of the second operand B), the result may be considered by the SALU 210 to be “1”. Determining and evaluating ranges of the operands may permit to reduce the precision of operation execution. This may help to reduce the energy consumption by SALU 210.

Determining whether the first operand is “sufficiently close” to the second operand may be provided by determining ranges of one or of both operands and considering these ranges of the operands in determining whether to add, by the register 220, a flag 310 to the status notification 230. Preferably, the ranges of the operands may be determined in the register 220. This may permit to determine whether to add, by the register 220, a flag 310 to the status notification 230. In at least one embodiment, SALU 210 may determine ranges of operands and use the ranges of the operands to determine whether to reassign the execution of the operation to the expedited routine 255 or to the conventional routine 250. For example, when the first operand (the value of the first operand and/or the range of the first operand) is within the range of the second operand and/or predetermined constant (for example, 0, 1, 2, etc.), SALU 210 may redirect the execution of the operation towards the expedited routine 255.

In at least one embodiment, using the ranges to determine the status notification 230 and/or readdressing of the execution towards expedited routine 255 may depend on a condition of the energy source (such as, for example, a battery) connected to the SALU 210 and/or register 220. An indication of the available energy and/or an indication of allotted energy (referred to herein as an “indication of available or allotted energy”) may be received by the register 220 and/or SALU 210 from the energy source: whether the available or allotted energy of the energy source is low (less than the threshold level) or high enough (equal to or higher than the threshold level). For example, when the available or allotted energy of the energy source is lower than the threshold level, SALU 210 may determine and evaluate the ranges of the operands in order to readdress the execution towards the expedited routine 255, however, when the available or allotted energy of the energy source is equal to or higher than the threshold level, the SALU 210 may execute the evaluations and comparison of the operands with regards to the predetermined conditions at the full precision (in other words, using values of the first and second operands as received by the SALU 210 and the register 220) without resorting to determining and evaluating the ranges of the operands.

In at least one embodiment, the register 220 may provide a specific flag 310 when the available or allotted energy of the energy source is lower than the pre-determined threshold level, which may signal to SALU 210 that an approximation may be performed. For example, for an angle of 15 degrees or less, expressed in radians, the angle and the sinus of the angle may be considered by the register 220 and SALU 210 to be (approximately) equal. If an indication that the available or allotted energy of the energy source is lower than the threshold level, is received by the SALU 210 (via the status notification 230 or directly from the energy source), SALU 210 may readdress the execution of the operation towards the expedited routine 255 which may use the approximate values of the operand(s). For example, SALU 210 may provide “1” as an output for the operation A/B when the value or the range of operand A is within the range of operand B.

In at least one embodiment, the status notification 230 may comprise several flags 310 each indicating fulfillment of one of the predetermined conditions. For example, the predetermined condition of the energy source (such as, for example, a battery) may be one of the predetermined conditions and may correspond to one flag in the status notification 230.

Referring again to FIGS. 2-4, in at least one embodiment, the apparatus 200 for accelerated processing of an arithmetic operation comprises the operand pre-arithmetic status register 220 and the modified arithmetic logic unit 210 (also referred to herein as SALU 210). According to an embodiment, the operand pre-arithmetic status register 220 is configured to receive the first operand 101 and the second operand 102 and to generate the status notification 230 that flags that one of predetermined combinatory conditions between the first operand 101 and the second operand 102 is met. According to an embodiment, the modified arithmetic logic unit 210 comprises the electronic logic circuit. The electronic logic circuit may be configured to: receive the first operand 101 and the second operand 102, and the status notification 230, and in response to receiving the status notification 230 from the operand pre-arithmetic status register 220 that comprises at least one flag 310 indicating that one of the predetermined combinatory conditions is met, readdress execution of the arithmetic operation by the modified arithmetic logic unit 210 towards an expedited routine 255 (of the modified arithmetic logic unit 210). As discussed above, the expedited routine 255 may have less calculation cycles to output an operation result than a conventional routine 250. In at least one embodiment, the conventional routine 250 is executed in response to the status notification 230, which is received from the operand pre-arithmetic status register 220, being the blank status notification. In at least one embodiment, the expedited routine 255 may provide approximate calculations. Such approximate calculations may be executed when the corresponding flag is received in the status notification 230 by the modified arithmetic logic unit 210.

In at least one embodiment, the operand pre-arithmetic status register may be configured to receive an operation indication 205. The generating, by the operand pre-arithmetic status register, the status notification may be further based on the operation indication 205. In at least one embodiment, in response to receiving the status notification from the operand pre-arithmetic status register that comprises at least one flag 310 indicating that one of the predetermined combinatory conditions is met, the SALU 210 may analyze the operation indication 205 and readdress the execution of the operation to the expedited routine 255 (which is located within the SALU 210) based on the operation indication 205.

The electronic logic circuit of the SALU 210 may be configured to implement combinatorial logics. The electronic logic circuit may be configured to implement sequential logics. In at least one embodiment, the status notification 230 may be a series of bits having at least one bit for flagging one of the predetermined combinatory conditions. A position of the bit with a flag 310 in the status notification 230 may correspond to a specific one of the predetermined combinatory conditions. In some embodiments, the modified arithmetic logic unit 210 may be configured to execute an additional microcode to redirect at least one operand to a pre-determined pipeline based on the status notification 230 received. Receiving the first operand 101 and the second operand 102 may comprise receiving an operation indication indicative of the arithmetic operation to be performed with the first operand 101 and the second operand 102.

In at least one embodiment, the operand pre-arithmetic status register 220 (also referred to herein as register 220) for assisting a modified arithmetic logic unit to accelerate processing of an arithmetic operation is configured to receive a first operand and a second operand, and generate a status notification to be transmitted to the modified arithmetic logic unit. As described above, the status notification 230 may be a sequence of bits, one of the bits serving as a flag of the predetermined combinatory condition. The position of the flag 310 in the sequence of bits may indicate the predetermined combinatory condition between the first operand 101 and the second operand 102.

In at least one embodiment, the method 400 for accelerated processing of an arithmetic operation as described herein may be executed. The method 400 is executable by an apparatus comprising an operand pre-arithmetic status register and a modified arithmetic logic unit. In at least one embodiment, the method 400 (illustrated in FIG. 4) comprises: receiving, at step 402, by the operand pre-arithmetic status register, a first operand and a second operand; generating, by the operand pre-arithmetic status register, at step 410, a status notification 230 that flags that one of predetermined combinatory conditions between the first operand 101 and the second operand 102 is met; receiving, by the modified arithmetic logic unit 210, the first operand 101 and the second operand 102 and the status notification 230, at step 412; and, in response to receiving the status notification from the operand pre-arithmetic status register 220 that comprises a flag indicating that one of the predetermined combinatory conditions is met, readdressing execution of the arithmetic operation, by the modified arithmetic logic unit, towards an expedited routine 255 corresponding to the flag in the status notification, the expedited routine having less calculation cycles than a conventional routine 250 executed when the status notification is a blank status notification. For example, if the status notification has no flag.

The method 400 may also comprise receiving, by the operand pre-arithmetic status register 220, the operation indication 205. Generating, by the operand pre-arithmetic status register 220, the status notification 230 may be further based on the operation indication 205. The method may further comprise executing, by the modified arithmetic logic unit 210, an additional microcode to redirect at least one operand to a pre-determined pipeline based on the status notification 230 received. Receiving the first operand and the second operand may comprise receiving an indication of the arithmetic operation to be performed with the first operand and the second operand. The method may further comprise assigning to a pre-determined bit of the status notification a value of 1 in response to the predetermined combinatory conditions between the first operand and the second operand being met.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An apparatus for accelerated processing of an arithmetic operation, the apparatus comprising:
an operand pre-arithmetic status register configured to receive a first operand and a second operand and to generate a status notification that flags that one of predetermined combinatory conditions between the first operand and the second operand is met; and
a modified arithmetic logic unit comprising an electronic logic circuit configured to:
receive the first operand and the second operand, and the status notification, and
in response to receiving the status notification from the operand pre-arithmetic status register that comprises at least one flag indicating that one of the predetermined combinatory conditions is met, readdress execution of the arithmetic operation by the modified arithmetic logic unit towards an expedited routine having less calculation cycles to output an operation result than a conventional routine, the conventional routine being executed in response to the status notification, received from the operand pre-arithmetic status register, being a blank status notification.

2. The apparatus of claim 1, wherein the operand pre-arithmetic status register is configured to receive an operation indication and wherein the generating, by the operand pre-arithmetic status register, the status notification is further based on the operation indication.

3. The apparatus of claim 1, wherein the modified arithmetic logic unit is configured to receive an operation indication and wherein, in response to receiving the status notification from the operand pre-arithmetic status register that comprises at least one flag indicating that one of the predetermined combinatory conditions is met, analyze the operation indication and readdress the execution of the arithmetic operation to the expedited routine based on the operation indication.

4. The apparatus of any one of claims 1 to 3, wherein the electronic logic circuit is configured to implement combinatorial logics.

5. The apparatus of any one of claims 1 to 3, wherein the electronic logic circuit is configured to implement sequential logics.

6. The apparatus of any one of claims 1 to 5, wherein the status notification is a series of bits having at least one bit for flagging one of the predetermined combinatory conditions.

7. The apparatus of claim 6, wherein a position of the bit with a flag in the status notification corresponds to a specific one of the predetermined combinatory conditions.

8. The apparatus of any one of claims 1 to 7, wherein the modified arithmetic logic unit is configured to execute an additional microcode to redirect at least one operand to a pre-determined pipeline based on the status notification received.

9. The apparatus of any one of claims 1 to 8, wherein receiving the first operand and the second operand comprises receiving an operation indication indicative of the arithmetic operation to be performed with the first operand and the second operand.

10. The apparatus of any one of claims 1 to 9, wherein the status notification is generated based on an indication of available or allotted energy of an energy source received by the operand pre-arithmetic status register.

11. The apparatus of any one of claims 1 to 10, wherein the status notification is generated based on an indication of available or allotted energy of an energy source received by the modified arithmetic logic unit.

12. The apparatus of any one of claims 1 to 11, wherein the readdressing the execution of the arithmetic operation by the modified arithmetic logic unit is based on an indication of available or allotted energy of an energy source received by the modified arithmetic logic unit.

13. The apparatus of any one of claims 1 to 12, wherein the status notification is generated based on determining and comparing a first range of the first operand and a second range of the second operand.

14. The apparatus of any one of claims 1 to 13, wherein the operand pre-arithmetic status register comprises logic gates each logic gate configured to recognize at least one predetermined combinatory condition.

15. An operand pre-arithmetic status register for assisting a modified arithmetic logic unit to accelerate processing of an arithmetic operation, the operand pre-arithmetic status register configured to:
receive a first operand and a second operand, and
generate a status notification to be transmitted to the modified arithmetic logic unit, the status notification being generated based on a predetermined combinatory condition being met between the first operand and the second operand.

16. The operand pre-arithmetic status register of claim 15, wherein the status notification is a sequence of bits, one of the bits serving as a flag of the predetermined combinatory condition.

17. The operand pre-arithmetic status register of claim 16, wherein a position of the flag in the sequence of bits indicates the predetermined combinatory condition between the first operand and the second operand.

18. The operand pre-arithmetic status register of any one of claims 1 to 17, further comprising logic gates, each logic gate configured to recognize at least one predetermined combinatory condition.

19. A method for accelerated processing of an arithmetic operation, the method executable by an apparatus comprising an operand pre-arithmetic status register and a modified arithmetic logic unit, the method comprising:
receiving, by the operand pre-arithmetic status register, a first operand and a second operand;
generating, by the operand pre-arithmetic status register, a status notification that flags that one of predetermined combinatory conditions between the first operand and the second operand is met;
receiving, by the modified arithmetic logic unit, the first operand and the second operand and the status notification; and
in response to receiving the status notification from the operand pre-arithmetic status register that comprises a flag indicating that one of the predetermined combinatory conditions is met, readdressing execution of the arithmetic operation, by the modified arithmetic logic unit, towards an expedited routine corresponding to the flag in the status notification, the expedited routine having less calculation cycles than a conventional routine executed when the status notification is a blank status notification.

20. The method of claim 19, further comprising receiving, by the operand pre-arithmetic status register, an operation indication and wherein the generating, by the operand pre-arithmetic status register, the status notification is further based on the operation indication.

21. The method of any one of claim 19 or 20, wherein the status notification is a sequence of bits having at least one bit for flagging one of the predetermined combinatory conditions.

22. The method of claim 21, wherein a position of a bit with a flag in the status notification corresponds to a specific one of the predetermined combinatory conditions.

23. The method of any one of claims 19 to 22, further comprising executing, by the modified arithmetic logic unit, an additional microcode to redirect at least one operand to a pre-determined pipeline based on the status notification received.

24. The method of claims 19 to 23, wherein receiving the first and the second operand comprises receiving an indication of the arithmetic operation to be performed with the first operand and the second operand.

25. The method of claims 19 to 24, further comprising assigning to a pre-determined bit of the status notification a value of 1 in response to the predetermined combinatory conditions between the first operand and the second operand being met.

26. The method of claims 19 to 25, wherein generating the status notification is based on an indication of available or allotted energy of an energy source received by the operand pre-arithmetic status register.

27. The method of claims 19 to 26, wherein generating the status notification is based on an indication of available or allotted energy of an energy source received by the modified arithmetic logic unit.

28. The method of claims 19 to 27, wherein the readdressing the execution of the arithmetic operation by the modified arithmetic logic unit is based on an indication of available or allotted energy of an energy source received by the modified arithmetic logic unit.

29. The method of claims 19 to 28, wherein generating the status notification is based on determining and comparing a first range of the first operand and a second range of the second operand.
